(19) United States
(12) Patent Application Publication
(10) Pub. No.: US 2025/0230853 A1
(43) Pub. Date: Jul. 17, 2025

(54) DAMPING FORCE ADJUSTMENT DEVICE

(71) Applicant: HL Mando Corporation, Pyeongtaek-si (KR)

(72) Inventors: Jongsun LEE, Pyeongtaek-si (KR); Wonbeen IM, Pyeongtaek-si (KR)

(21) Appl. No.: 18/778,385

(22) Filed: Jul. 19, 2024

(30) Foreign Application Priority Data
Jan. 16, 2024 (KR) 10-2024-0006571

(51) Int. Cl. F16F 9/50; F16F 9/34

(52) U.S. Cl. CPC F16F 9/50; F16F 9/34

(57) ABSTRACT

A damping force adjustment device is provided. A damping force adjustment device comprises a pilot poppet raised and lowered by a magnetic force and a main poppet in which at least a portion of the pilot poppet is accommodated. Moreover, the damping force adjustment device comprises an elastic unit between at least a portion of an outer peripheral surface of the pilot poppet and an inner peripheral surface of one region of the main poppet where the pilot poppet is accommodated.

### CROSS-REFERENCE TO RELATED APPLICATIONS

This application claims benefit and priority to Korean Patent Application No. 10-2024-0006571, filed on Jan. 16, 2024, with the Korean Intellectual Property Office, the disclosure of which is incorporated herein in its entirety by reference.

### TECHNICAL FIELD

Embodiments of the present disclosure relate to a damping force adjustment device, and more specifically, to a damping force adjustment device that is arranged inside a cylinder of a suspension device and adjusts a damping force.

### BACKGROUND

A damping force adjustment device is arranged inside a cylinder of a suspension device. The damping force adjustment device adjusts a damping force of a fluid inside the cylinder according to a compression stroke or tension stroke inside the cylinder.

Therefore, the damping force adjustment device adjusts the damping force provided by the suspension device according to road conditions on which a vehicle is traveling or a degree requested by a passenger.

However, this damping force adjustment device has a problem in that a component in contact with a poppet is damaged by a force applied to the poppet that is moved to adjust the damping force. Specifically, when repeated hard damping force control is required, a large load is provided to the poppet, and there is a problem that the component in contact with the poppet is also deformed by receiving a large force.

Therefore, there is a problem in that it becomes difficult for the damping force adjustment device to effectively adjust the damping force due to the deformed configuration, thereby shortening a replacement cycle thereof or an exchange cycle of the configuration.

### SUMMARY

An embodiment of the present disclosure provides a damping force adjustment device that can effectively elastically deform and form a damping force even when a pilot poppet is raised and lowered by a magnetic force.

According to an embodiment of the present disclosure, there is provided a damping force adjustment apparatus comprsing a pilot poppet raised and lowered by a magnetic force and a main poppet in which at least a portion of the pilot poppet is accommodated, the damping force adjustment apparatus including: an elastic unit arranged between at least a portion of an outer peripheral surface of the pilot poppet and an inner peripheral surface of one region of the main poppet where the pilot poppet is accommodated.

The pilot poppet may comprise a pilot body, a pilot protrusion having one region formed on the pilot body to protrude toward the main poppet, and a pilot locking portion formed on an outer peripheral surface of the pilot protrusion to come in contact with one side of the elastic unit.

The main poppet may comprise a main body having an accommodating region formed to accommodate at least a portion of the pilot body, and a main locking portion in which one region of the main body protrudes toward a central portion of the accommodation region to support the other side of the elastic unit.

The main poppet may further comprise a main flow path formed inside the main body, and a main protrusion arranged to surround one side of the main flow path and protruding toward the pilot protrusion on the main body.

The elastic unit may be elastically variable according to a movement of the pilot body.

The pilot poppet may further comprise a pilot flow path formed on the pilot body.

The elastic unit may include an elastic body having a central portion formed to accommodate a portion of the pilot protrusion, and an elastic flow path formed on the elastic body to guide a movement of a fluid.

One region of the pilot body adjacent to the pilot protrusion may be spaced apart from the elastic body.

At least a portion of the elastic flow path may be arranged to face the pilot flow path.

The elastic unit may further comprise a plurality of outer periphery opening regions having one region formed on an outer periphery of the elastic body to be recessed toward the central portion and spaced apart along the outer periphery of the elastic body.

The elastic flow path may be arranged so that one side is adjacent to the central portion and the other side is adjacent to an outside of the elastic body.

When the pilot poppet is lowered, at least a portion of the pilot protrusion of the pilot body may face the main protrusion.

According to an embodiment of the present disclosure, there is provided a damping force adjustment apparatus comprise a pilot poppet raised and lowered by a magnetic force and a main poppet in which at least a portion of the pilot poppet is accommodated, the damping force adjustment apparatus including: an elastic unit in which at least a portion of the pilot poppet is formed with a central portion in which a region protruding toward the main poppet is inserted.

The elastic unit may include an annular elastic body whose inner side is in contact with the pilot poppet and whose outer side is supported by the main poppet, and an elastic flow path formed on the elastic body to guide a movement of a fluid.

The elastic body may be pressed and deformed by a protruding area of the pilot poppet when the pilot poppet is lowered in a direction adjacent to the main poppet.

The elastic body may be in contact with at least a portion of an outer periphery of the protruding area of the pilot poppet.

An accommodation region may be formed in the main poppet to accommodate at least a portion of the pilot poppet and the elastic unit.

A portion of one surface of the elastic body may be in contact with a protruding area of the pilot poppet, and a remainder of the one surface of the elastic body may be arranged to be spaced apart from a non-protrusion region of the pilot poppet.

One region of the central portion of the pilot poppet may be formed to protrude, and a remaining region of the pilot poppet may be formed to be stepped from the protrusion region.

The stepped region of the pilot poppet may provide a space in which the elastic unit is deformable elastically.

### Advantageous Effects

According to an embodiment of the present disclosure, the damping force adjustment device effectively supports the elastic deformation of the elastic unit by preventing contact of the elastic unit between the main poppet and the pilot poppet and prevents the elastic unit from being deformed to exceed an elastic deformation.

Therefore, the damping force adjustment device can prevent damage caused by changing of an arrangement structure of the elastic unit, thereby improving a service life and responsiveness of the damping force adjustment device.

### BRIEF DESCRIPTION OF THE DRAWINGS

FIG. 1 illustrates a cross section of a damping force adjustment device according to one embodiment of the present disclosure.

FIG. 2 is an enlarged view of an A region of FIG. 1.

FIG. 3 illustrates a cross section in a lowered state of a pilot poppet of a damping force adjustment device according to one embodiment of the present disclosure.

FIG. 4 is an enlarged view of a B region of FIG. 3.

FIG. 5 illustrates a plan view of an elastic unit according to one embodiment of the present disclosure.

FIG. 6 illustrates a perspective view of an elastic unit according to one embodiment of the present disclosure.

### DETAILED DESCRIPTION

Hereinafter, with reference to the attached drawings, embodiments of the present disclosure will be described in detail so that those skilled in the art can easily perform the present disclosure. The present disclosure may be implemented in several different forms and is not limited to the embodiments described herein.

Please note that the drawings are schematic and not drawn to scale. The relative dimensions and proportions of parts in the drawings are illustrated exaggerated or reduced in size for clarity and convenience in the drawings, and any dimensions are illustrative only and are not limiting. Moreover, for identical structural elements or parts illustrated in two or more drawings, the same reference numerals are used to indicate similar features.

The embodiment of the present disclosure specifically represents an ideal embodiment of the present disclosure. As a result, various variations of the diagram are expected. Therefore, the embodiment is not limited to the specific shape of the region illustrated, and also includes variations in shape due to manufacturing, for example.

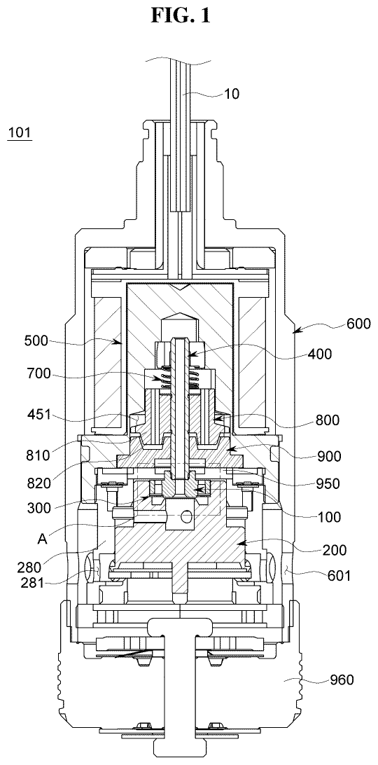

Hereinafter, with reference to FIGS. 1 to 6, a damping force adjustment device 101 according to one embodiment of the present disclosure will be described.

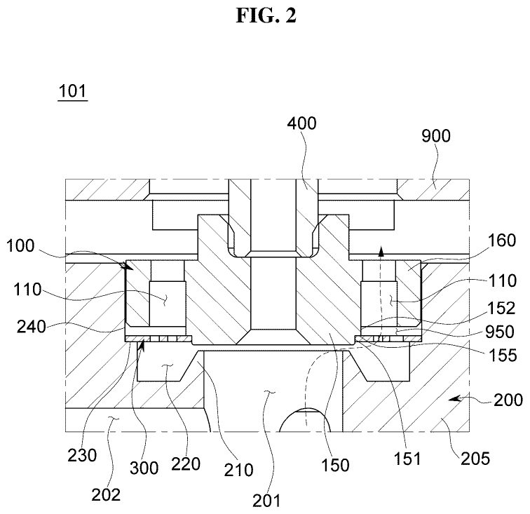

The damping force adjustment device 101 is installed inside a cylinder of a suspension device to adjust a damping force. Specifically, the damping force adjustment device 101 includes a pilot poppet 100 and a main poppet 200, as illustrated in FIGS. 1 and 2. The pilot poppet 100 is raised and lowered by magnetic force. Additionally, at least a portion of the pilot poppet 100 is accommodated in the main poppet 200. The pilot poppet 100 can control a damping force by controlling a flow of a fluid passing through the main poppet 200 as the pilot poppet is raised or lowered.

The damping force adjustment device 101 according to one embodiment of the present disclosure includes an elastic unit 300, as illustrated in FIGS. 1 to 4.

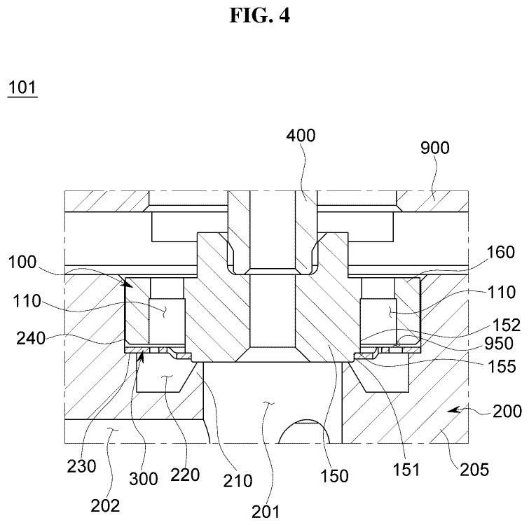

The elastic unit 300 is arranged between at least a portion of an outer peripheral surface of the pilot poppet 100 and an inner peripheral surface of one region of the main poppet 200 in which the pilot poppet 100 is accommodated. In addition, the elastic unit 300 can reduce shock between the pilot poppet 100 and the main poppet 200, as illustrated in FIG. 4, when the pilot poppet 100 moves in a direction adjacent to the main poppet 200. When the pilot poppet 100 is moved in the direction adjacent to the main poppet 200, the elastic unit 300 is elastically deformed and can adjust the damping force.

As such, the elastic unit 300 of the damping force adjustment device 101 according to one embodiment of the present disclosure is arranged between at least a portion of the outer peripheral surface of the pilot poppet 100 and the inner peripheral surface of one region of the main poppet 200, and can effectively prevent the deformation of the elastic unit 300 when the pilot poppet is lowed in a state where a strong load is applied to the pilot poppet.

Additionally, the pilot poppet 100 according to one embodiment of the present disclosure may include a pilot body 160, a pilot protrusion 150, and a pilot locking portion 155, as illustrated in FIG. 2.

The pilot body 160 may be formed to have an approximately “circular” cross section. Additionally, at least a portion of the pilot body 160 is inserted into the inner periphery of the main poppet 200, and a region of the pilot body that does not face the main poppet 200 is connected to a plunger rod 400. Accordingly, the pilot body 160 may move together with the movement of the plunger rod 400.

The pilot protrusion 150 may be formed on the pilot body 160 with one region protruding toward the main poppet 200. Specifically, the pilot protrusion 150 may be formed on the pilot body 160 with one region protruding toward the main poppet 200 in a direction parallel to the central portion of the main poppet 200.

For example, the pilot protrusion 150 may be formed to protrude along a direction parallel to the central portion of the main poppet 200 in a direction in which one region of the central portion of the pilot body 160 is adjacent to the main poppet 200.

The pilot locking portion 155 is formed on the outer peripheral surface of the pilot protrusion 150 and may be in contact with one side of the elastic unit 300.

For example, the pilot locking portion 155 is formed by the outer peripheral surface of one region of the pilot protrusion 150 being recessed, and one side of the elastic unit 300 is in contact with the pilot locking portion 155 so that the elastic unit can move together when the pilot body 160 is lowered.

Additionally, the main poppet 200 according to one embodiment of the present disclosure may include a main body 205 and a main locking portion 230, as illustrated in FIG. 2.

An accommodation region 240 may be formed in the main body 205. The accommodation region 240 may be formed so that one region of the central portion of the main body 205 is recessed and at least a portion of the pilot body 160 can be accommodated. Specifically, one side of the accommodation region 240 is formed open to guide the raising and lowering of the pilot body 160.

For example, a diameter of the inner peripheral surface of the accommodation region 240 may be the same as a diameter of the outer peripheral surface of the pilot body 160, or may be formed with a small tolerance. That is, a wall portion of the accommodation region 240 may support the raising or lowering of the outer peripheral surface of the pilot body 160.

The main locking portion 230 is formed to support the other side of the elastic unit 300. Additionally, the main locking portion 230 may be formed by protruding an inner peripheral region of the main body 205 toward the central portion of the accommodation region 240.

Accordingly, when assembling the elastic unit 300 in the accommodation region 240, the installation location of the elastic unit 300 can be easily determined. That is, the outer periphery of the elastic unit 300 is contact-supported by the wall portion of the accommodation region 240 of the main body 205, and thus, a separate device for centering is not required when assembling the elastic unit 300, and when the damping force adjustment device 101 is manufactured, the elastic unit 300 can be easily assembled.

Accordingly, one side of the elastic unit 300 may be in contact with the pilot locking portion 155 and the other side thereof may be supported by the main locking portion 230.

Specifically, the pilot body 160 and the elastic unit 300 may be arranged in the accommodation region 240.

In addition, the main poppet 200 according to one embodiment of the present disclosure may further include a main flow path 201 and main protrusion 210.

The main flow path 201 may be formed to move fluid within the main body 205. Specifically, the main flow path 201 may be formed parallel to the inside of the main body 205 along a longitudinal direction of the main body 205. Additionally, one side of the main flow path 201 may be formed open to communicate with the accommodation region 240.

The main protrusion 210 is arranged to surround one side of the main flow path 201 and may be formed to protrude toward the pilot protrusion 150 on the main body 205. Specifically, the main protrusion 210 may have one region of the central portion of the main body 205 protruding toward the pilot protrusion 150. Additionally, the main protrusion 210 may be arranged to face one region of the pilot protrusion 150.

For example, the main locking portion 230 may be arranged relatively closer to the open region of the accommodation region 240 of the main body 205 than the main protrusion 210. That is, the main protrusion 210 may be arranged in a relatively lower position than the main locking portion 230, so that the main locking portion 230 can effectively support the deformation of the elastic unit when the pilot body 160 is lowered.

Additionally, the pilot poppet 100 according to one embodiment of the present disclosure may further include a pilot flow path 110.

The pilot flow path 110 may be formed through the pilot body 160. Specifically, the pilot flow path 110 may be formed through a region of the pilot body 160 where the pilot protrusion 150 is not formed.

For example, the fluid that has passed through the main flow path 201 flows into the pilot flow path 110 and passes through the pilot flow path.

Additionally, a plurality of pilot flow paths 110 may be arranged radially spaced apart from each other on the pilot body 160 with the pilot protrusion 150 as the center.

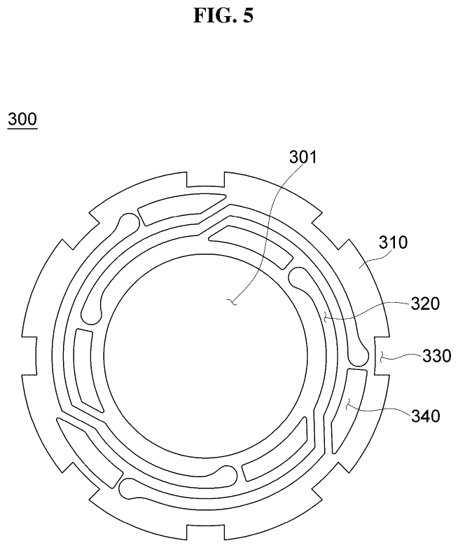

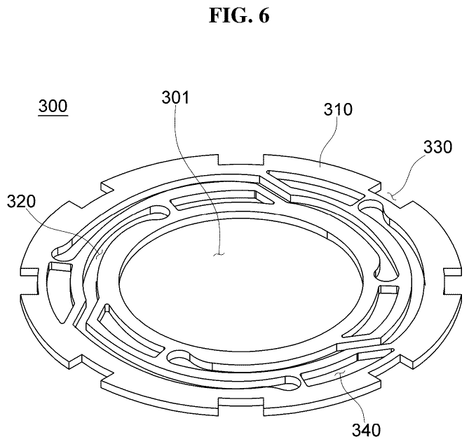

Additionally, the elastic unit 300 according to one embodiment of the present disclosure may include an elastic body 310 and an elastic flow path 320, as illustrated in FIGS. 5 and 6.

The elastic body 310 may have a central portion 301 formed therethrough. A portion of the pilot protrusion 150 may be accommodated in the central portion 301.

For example, the elastic body 310 may be formed in an annular plate shape and have the central portion 301 formed therethrough.

The elastic flow path 320 is formed on the elastic body 310 to guide the movement of fluid. Specifically, the elastic flow path 320 can guide the fluid that has passed through the main flow path 201 to move to the pilot flow path 110.

Additionally, one region of the pilot body 160 adjacent to the pilot protrusion 150 according to one embodiment of the present disclosure may be spaced apart from the elastic body 310, as illustrated in FIG. 2.

One region of the pilot protrusion 150 may be accommodated in the central portion 301 formed in the elastic body 310, and one region of the pilot body 160 adjacent to the pilot protrusion 150 may be spaced apart from the elastic body 310. Specifically, the region of the pilot body 160 in which the pilot protrusion 150 is not formed has a lower height than the region in which the pilot protrusion 150 is formed, and may be spaced apart from the elastic body 310.

As illustrated in FIGS. 2 and 4, a space 950 between the elastic body 310 and one region of the spaced pilot body 160 may provide a space for deformation of the elastic body 310 when the elastic body is deformed. Additionally, this space 950 may provide a separation region so that the elastic body 310 is not pressed between the pilot body 160 and the main body 205 when the pilot body 160 moves.

In addition, at least a portion of the elastic flow path 320 of the damping force adjustment device 101 according to one embodiment of the present disclosure may be arranged to face the pilot flow path 110, as illustrated in FIGS. 2 and 5.

At least a portion of the elastic flow path 320 is arranged to face the pilot flow path 110. Therefore, when the fluid supplied through the main flow path 201 moves through the pilot flow path 110, the fluid passes through the elastic flow path 320, and fluid friction due to interference can be reduced.

Additionally, the elastic unit 300 according to one embodiment of the present disclosure may further include a plurality of outer periphery opening regions 330.

The outer periphery opening region 330 may be formed by a region of the outer periphery of the elastic body 310 being recessed toward the central portion 301. Additionally, the plurality of outer periphery opening regions 330 may be formed spaced apart along the outer periphery of the elastic body 310.

For example, this outer periphery opening region 330 may be formed to face the main locking portion 230. That is, the weight of the elastic unit 300 can be reduced by the outer periphery opening region 330, and the elastic body 310 can be effectively supported by the main locking portion 230. In this case, the outer periphery opening region 330 may also be arranged to face a region in which the pilot flow path 110 is not formed among the regions of the pilot body 160 in which the pilot protrusion 150 is not formed.

In addition, the elastic flow path 320 according to one embodiment of the present disclosure may be arranged so that one side is adjacent to the central portion 301 and the other side is adjacent to the outside of the elastic body 310, as illustrated in FIGS. 2 and 5.

The elastic flow path 320 may provide a space for deformation so that the elastic body 310 can be elastically deformed in addition to the movement of fluid. In other words, the elastic flow path 320 may provide a degree of freedom for deformation of the elastic body 310.

The elastic flow path 320 may be formed in approximately a “half-arc” shape, with one side adjacent to the central portion 301 and the other side adjacent to the outside of the elastic body 310.

As an example, the plurality of elastic flow paths 320 may be arranged on the elastic body 310 to be spaced apart from each other. As illustrated in FIGS. 5 and 6, at least some of the plurality of elastic flow paths 320 may be arranged to overlap on the same radius.

Additionally, at least a portion of the pilot protrusion 150 according to one embodiment of the present disclosure may be arranged to face the main protrusion 210.

When the pilot poppet 100 is lowered, one end surface of the pilot protrusion 150 may be arranged to face one end surface of the main protrusion 210.

When the pilot poppet 100 is lowered, one end surface of the pilot protrusion 150 may move in a direction to face and be adjacent to one end surface of the main protrusion 210.

Therefore, the elastic unit is not arranged between one surface of the pilot protrusion 150 and one surface of the main protrusion 210, and thus, the elastic unit can be prevented from being pressed between the pilot protrusion 150 and the main protrusion 210 and the elastic unit can be effectively presented from exceeding an elastic range.

In addition, the pilot protrusion 150 according to one embodiment of the present disclosure may include a first protrusion region 151 and a second protrusion region 152, as illustrated in FIGS. 2 and 4.

The first protrusion region 151 and the second protrusion region 152 may be arranged adjacent to each other with the pilot locking portion 155 interposed therebetween.

A diameter of the first protrusion region 151 may be relatively smaller than a diameter of the second protrusion region 152. Additionally, the first protrusion region 151 may be inserted into the central portion 301.

For example, the inner peripheral surface of the central portion 301 may be arranged to face the outer peripheral surface of the first protrusion region 151.

The first protrusion region 151 and the pilot locking portion 155 may be arranged adjacent to each other.

The second protrusion region 152 may be arranged adjacent to the pilot body 160 adjacent to the pilot locking portion 155.

The second protrusion region 152 may be arranged adjacent to the pilot locking portion 155.

A height of the second protrusion region 152 may be formed to maintain a separation distance between the elastic body 310 and the pilot body 160 in which the pilot protrusion 150 is not formed. The pilot body 160 in which the second protrusion region 152 and the pilot protrusion 150 are not formed may be formed to be stepped.

Specifically, a portion of one surface of the elastic body 310 may be formed to face the pilot locking portion 155.

That is, the first protrusion region 151 and the second protrusion region 152 may be formed to be stepped.

In addition, the main poppet 200 of the damping force adjustment device 101 according to one embodiment of the present disclosure may include an elastic deformation region 222 formed to be recessed on the main body 205 around the main protrusion 210.

The elastic deformation region 222 is formed to be recessed between the main protrusion 210 and the main locking portion 230. Accordingly, when the pilot protrusion 150 of the pilot body 160 moves in a direction adjacent to the main protrusion 210, a space can be formed so that the inside of the elastic body 310, which comes into contact with the pilot locking portion 155 and moves together with the pilot body 160, is deformed. Additionally, the elastic deformation region 222 may store a portion of the fluid that has passed through the main flow path 201 when the fluid moves to the pilot flow path 110.

In addition, the elastic unit 300 according to one embodiment of the present disclosure may further include an auxiliary opening region 340, as illustrated in FIGS. 5 and 6.

The auxiliary opening region 340 may be formed through the elastic flow path 320 and the central portion 301 on the elastic body 310, or may be formed between the elastic flow path 320 and the outer periphery opening region 330 on the elastic body 310.

A plurality of auxiliary opening regions 340 may be arranged to be spaced apart from each other. The auxiliary opening region 340 may provide a degree of freedom for the elastic body 310 to be easily elastically deformed.

In addition, the damping force adjustment device 101 according to one embodiment of the present disclosure may further include a piston rod 10, an external housing 600, an external housing through-hole 601, a solenoid 500, a plunger 800, an elastic member 700, a piston valve 960, an internal housing 280, and an internal housing through-hole 281, as illustrated in FIGS. 1 to 6.

An external housing through-hole 601 may be formed on a side surface of the external housing 600. A piston rod 10 may be coupled to one side of the external housing 600. A piston valve 960 may be coupled to the other side of the external housing 600. Specifically, a flow path is formed inside the piston valve 960, and a valve may be installed to open and close the flow path formed in the piston valve 960 by the pressure of the fluid.

For example, this damping force adjustment device 101 may be installed inside the piston of the suspension device. In addition, the damping force adjustment device 101 is moved in a direction controlled by the volume inside the piston, and the damping force of the piston can be adjusted.

A rebound chamber may be formed in an upper portion centered on the piston valve 960, and a compression chamber may be formed in a lower portion centered on the piston valve 960. Specifically, the fluid that has passed through the piston valve 960 may move through the external housing through-hole 601, or the fluid that has passed through the external housing through-hole 601 may move through the piston valve 960. That is, the piston valve 960 may partition a rebound chamber and a compression chamber of the suspension device, and volumes of the rebound chamber and the compression chamber may vary according to the movement of the piston valve 960.

The solenoid 500 can control the raising or lowering of the plunger 800. The solenoid 500 may provide a magnetic force to raise or lower the plunger 800. This plunger 800 is combined with the plunger rod 400, and the pilot poppet 100 can be raised and lowered by moving the plunger rod 400. That is, one side of the plunger rod 400 is coupled with the pilot poppet 100.

Specifically, the plunger 800 moves downward when a control current is applied to the coil, and the plunger 800 is combined with the plunger rod 400 so that the pilot poppet 100 can also move downward. Accordingly, the damping force can be controlled by adjusting an opening amount of the fluid by moving the pilot poppet 100.

As an example, the plunger 800 according to one embodiment of the present disclosure may include an outer peripheral extension portion 810 in which one region of the outer periphery extends in a direction adjacent to the solenoid 500 and a lower extension portion 820 formed to extend in the downward direction.

The outer peripheral extension portion 810 extends radially toward the core of the solenoid 500 and can effectively receive current from the solenoid 500.

When the plunger 800 is lowered, the lower extension part 820 can guide the plunger 800 for the effective straight movement thereof. Specifically, a groove that can accommodate the lower extension portion 820 may be formed in the plunger housing 900, which accommodates the lower extension portion 820 and limits the lowering position of the plunger 800.

The elastic member 700 is arranged on the other side of the plunger rod 400 and can relieve the impact of the plunger 800 and the plunger rod 400 when the plunger rod 400 is restored to an original position thereof. Specifically, the elastic member 700 may be compressed when the plunger 800 is restored to the original position thereof. The elastic member 700 may be arranged inside a stator core to alleviate impact between the stator core and the plunger 800 when the plunger 800 is restored.

That is, an extension accommodation portion 451 capable of receiving and moving the outer extension portion 810 of the plunger 800 may be formed in the stator core.

The inner housing 280 may be arranged within the outer housing 600. Additionally, the main poppet 200 may be arranged within this inner housing 280. In addition, the inner housing through-hole 281 is formed on the outer periphery of the inner housing 280 to guide the movement of the fluid.

The fluid supplied through the outer housing through-hole 601 may be moved through the inner housing through-hole 281.

Additionally, the main poppet 200 according to one embodiment of the present disclosure may further include an inflow flow path 202.

The inflow flow path 202 is formed through the main body 205 in a lateral direction and can guide the fluid so that the fluid moves to the main flow path 201. For example, the fluid that has passed through the external housing through-hole 601 may pass through the inlet flow path 202 and then be guided to the main flow path 201.

Hereinafter, with reference to FIGS. 1 to 6, the operating process of the damping force adjustment device 101 according to one embodiment of the present disclosure will be described.

When the piston valve 960 moves in a direction where the volume of the rebound chamber decreases, the damping force adjustment device 101 also moves upward.

In this case, the damping force adjustment device 101 is operated according to road condition information or impact to be applied to the vehicle and passengers.

Specifically, during the extension stroke of the suspension device, the fluid in the rebound chamber passes through the piston valve 960 and flows into the compression chamber, thereby forming a damping force.

To adjust the damping force, the opening of the flow path can be adjusted by raising and lowering the main poppet 200 and the pilot poppet 100.

In order to implement a soft damping force during rebound, the elastic unit 300 may be in a state that is not pressurized by the pilot poppet 100, as illustrated in FIG. 2. Specifically, a portion of the fluid in the rebound chamber may pass through the external housing through-hole 601 and flow into the main flow path 201 through the inlet flow path 202.

In addition, the fluid introduced through the main flow path 201 may be supplied to the piston valve 960 after passing through the pilot flow path 110.

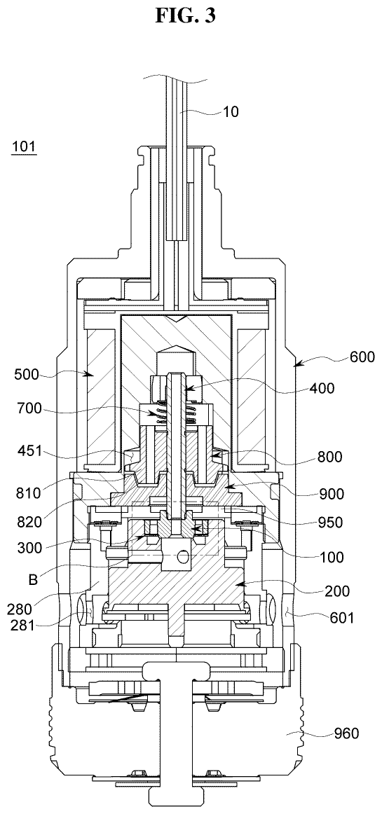

In this case, in order to further adjust the damping force as necessary, as illustrated in FIGS. 3 and 4, the solenoid 500 is controlled so that the pilot poppet 100 move while pressurizing the elastic unit to move the pilot poppet 100 in a direction adjacent to the main poppet 200.

Accordingly, the pilot protrusion 150 of the pilot poppet 100 is moved in a direction adjacent to the main protrusion 210, and the gap between the pilot poppet 100 and the main poppet 200 can be reduced. Additionally, when the pilot poppet 100 moves, the damping force can be controlled by the flow rate of the fluid that moves from the outer housing 600 to the inner housing 280 and then moves to the piston valve 960 through the main poppet 200.

Alternatively, during the compression stroke of the suspension device, the fluid in the compression chamber passes through the piston valve 960 and flows into the rebound chamber, thereby forming the damping force. Specifically, the damping force adjustment device 101 may adjust the position of the main poppet 200 by the fluid pressure according to the movement of the piston valve 960 and the damping force by the movement of the pilot poppet 100 according to the operation of the solenoid 500.

That is, even during the compression stroke of the suspension device, the damping force can be further adjusted by adjusting the position of the pilot poppet 100 according to the operation of the solenoid.

In other words, the soft damping force or hard damping force can be adjusted by the movement state of the pilot poppet 100 according to the operation of the solenoid 500.

With this configuration, the damping force adjustment device 101 according to one embodiment of the present disclosure can effectively prevent damage caused by deformation beyond the elastic region of the elastic unit by the specific arrangement structure of the elastic unit as described above.

Although embodiments of the present disclosure have been described above with reference to the attached drawings, those skilled in the art of the present disclosure will recognize that the present disclosure can be implemented in other specific forms without changing its technical idea or essential features.

Therefore, the embodiments described above should be understood in all respects as illustrative and not restrictive, and the scope of the present disclosure is indicated by the detailed description and the claims described later, and the meaning and scope of the claims and all changes or modified forms derived from the equivalent concept should be construed as being included in the scope of the present disclosure.

[Detailed Description of Main Elements]

| | |
|---|---|
| 100: pilot poppet | 101: damping force adjustment |
| 110: pilot flow path | 150: pilot protrusion |
| 155: pilot locking portion | 160: pilot body |
| 200: main poppet | 201: main flow path |
| 205: main body | 210: main protrusion |
| 230: main locking portion | 240: accommodation region |
| 300: elastic unit | 310: elastic body |
| 320: elastic flow path | 330: outer periphery opening region |

What is claimed is:

1. A damping force adjustment device comprising a pilot poppet raised and lowered by a magnetic force and a main poppet in which at least a portion of the pilot poppet is accommodated, the damping force adjustment device comprising:
an elastic unit arranged between at least a portion of an outer peripheral surface of the pilot poppet and an inner peripheral surface of one region of the main poppet where the pilot poppet is accommodated.

2. The damping force adjustment device of claim 1, wherein the pilot poppet comprises
a pilot body,
a pilot protrusion having one region formed on the pilot body to protrude toward the main poppet, and
a pilot locking portion formed on an outer peripheral surface of the pilot protrusion to come in contact with one side of the elastic unit.

3. The damping force adjustment device of claim 2, wherein the main poppet comprises
a main body having an accommodation region formed to accommodate at least a portion of the pilot body, and
a main locking portion in which one region of the main body protrudes toward a central portion of the accommodation region to support the other side of the elastic unit.

4. The damping force adjustment device of claim 3, wherein the main poppet further comprises
a main flow path formed inside the main body, and
a main protrusion arranged to surround one side of the main flow path and protruding toward the pilot protrusion on the main body.

5. The damping force adjustment device of claim 3, wherein the elastic unit is elastically variable according to a movement of the pilot body.

6. The damping force adjustment device of claim 4, wherein the pilot poppet further comprises a pilot flow path formed on the pilot body.

7. The damping force adjustment device of claim 6, wherein the elastic unit comprises
an elastic body having a central portion formed to accommodate a portion of the pilot protrusion, and
an elastic flow path formed on the elastic body to guide a movement of a fluid.

8. The damping force adjustment device of claim 7, wherein one region of the pilot body adjacent to the pilot protrusion is spaced apart from the elastic body.

9. The damping force adjustment device of claim 7, wherein at least a portion of the elastic flow path is arranged to face the pilot flow path.

10. The damping force adjustment device of claim 7, wherein the elastic unit further comprises a plurality of outer periphery opening regions having one region formed on an outer periphery of the elastic body to be recessed toward the central portion and spaced apart along the outer periphery of the elastic body.

11. The damping force adjustment device of claim 7, wherein the elastic flow path is arranged so that one side is adjacent to the central portion and the other side is adjacent to an outside of the elastic body.

12. The damping force adjustment device of claim 4, wherein when the pilot poppet is lowered, at least a portion of the pilot protrusion of the pilot body faces the main protrusion.

13. A damping force adjustment device comprising a pilot poppet raised and lowered by a magnetic force and a main poppet in which at least a portion of the pilot poppet is accommodated, the damping force adjustment device comprising:
an elastic unit in which at least a portion of the pilot poppet is formed with a central portion in which a region protruding toward the main poppet is inserted.

14. The damping force adjustment device of claim 13, wherein the elastic unit comprises
an annular elastic body whose inner side is in contact with the pilot poppet and whose outer side is supported by the main poppet, and
an elastic flow path formed on the elastic body to guide a movement of a fluid.

15. The damping force adjustment device of claim 14, wherein the elastic body is pressed and deformed by a protruding area of the pilot poppet when the pilot poppet is lowered in a direction adjacent to the main poppet.

16. The damping force adjustment device of claim 14, wherein the elastic body is in contact with at least a portion of an outer periphery of the protruding area of the pilot poppet.

17. The damping force adjustment device of claim 13, wherein an accommodation region is formed in the main poppet to accommodate at least a portion of the pilot poppet and the elastic unit.

18. The damping force adjustment device of claim 14, wherein a portion of one surface of the elastic body is in contact with a protruding area of the pilot poppet, and a remainder of the one surface of the elastic body is arranged to be spaced apart from a non-protrusion region of the pilot poppet.

19. The damping force adjustment device of claim 13, wherein one region of the central portion of the pilot poppet is formed to protrude, and a remaining region of the pilot poppet is formed to be stepped from the protrusion region.

20. The damping force adjustment device of claim 19, wherein the stepped region of the pilot poppet provides a space in which the elastic unit is deformable elastically.
